(19) United States
(12) Patent Application Publication
(10) Pub. No.: US 2025/0187312 A1
(43) Pub. Date: Jun. 12, 2025

(54) LAMINATE MATERIAL

(71) Applicant: Avon Polymer Products Limited, Wiltshire (GB)

(72) Inventors: Henry CHADWICK, Melksham (GB); Harry JAMES, Melksham (GB)

(73) Assignee: AVON POLYMER PRODUCTS LIMITED, Wiltshire (GB)

(21) Appl. No.: 18/845,588

(22) PCT Filed: Mar. 9, 2023
(86) PCT No.: PCT/EP2023/056084

§ 371 Date: Sep. 10, 2024

(30) Foreign Application Priority Data
Mar. 22, 2022 (GB) 2203983.8

(51) Int. Cl. B32B 25/10; A41D 19/00; B32B 1/00; B32B 3/30; B32B 5/02; B32B 5/26; B32B 25/18; B32B 37/10; B32B 37/12; B32B 37/16

(52) U.S. Cl. CPC B32B 25/10; A41D 19/0006; B32B 1/00; B32B 3/30; B32B 5/022; B32B 5/265; B32B 25/18; B32B 37/10; B32B 37/12; B32B 37/16; B32B 2262/106; B32B 2305/20; B32B 2307/724; B32B 2313/04; B32B 2319/00; B32B 2437/02; B32B 2571/00

(57) ABSTRACT

The invention provides a laminate material comprising a first layer formed of a rubber material, and a second layer formed of an activated carbon cloth, with the first layer and the second layer being joined together. The laminate material may be used in protective equipment and clothing, such as chemical, biological, radiological and nuclear (CBRN) protective clothing.

### CROSS-REFERENCE TO RELATED APPLICATION

This application is a U.S. National Phase application of International Application No. PCT/EP2023/056084, filed on Mar. 9, 2023; which claims priority of GB 2203983.8, filed on Mar. 22, 2022, all of which are incorporated herein by reference in their entirety.

### FIELD OF THE INVENTION

The present invention relates to a laminate material which can be used in protective clothing and/or protective equipment.

### BACKGROUND

Protective equipment is critical in a range of different fields. For example, in chemical, biological, radiological and nuclear (CBRN) defence, protective equipment is needed to protect the wearer against hazards that may be present in the environment. CBRN protective equipment such as gloves, boots and respirators typically include thick barrier materials which act to block permeation of dangerous substances through the clothing, to prevent the dangerous substances from reaching the wearer's skin. Typically, such barrier materials include rubber materials, such as butyl rubber, which provide adequate permeation resistance and are flexible so as to allow wearer movement. Permeation resistance of the barrier material can be increased by increasing a thickness of the barrier material, such that a thickness of the barrier material can be selected based on the types of hazards which are expected to be encountered by the wearer. However, increasing the thickness of the barrier material leads to reduced flexibility of the protective equipment and reduced wearer comfort, which may make it more difficult for the wearer to perform tasks in a high risk environment.

The present invention has been devised in light of the above considerations.

### SUMMARY OF THE INVENTION

The inventors have found that conventional CBRN protective equipment and clothing is typically highly bulky and cumbersome. In particular, due to the thickness of barrier materials required to provide adequate permeation resistance, a wearer may quickly become hot and uncomfortable, thus making it difficult to wear the protective clothing for extended periods of time. Additionally, the thickness of the barrier materials may restrict motion of the wearer. For example, bulky CBRN protective gloves may not provide the high levels of dexterity needed in order to complete certain complex tasks. The wearer's dexterity may be improved by reducing a thickness of the barrier material in the protective gloves, however this results in an increased risk to the wearer as permeability resistance of the gloves will be reduced.

At its most general, the present invention provides a laminate material which can be used in protective equipment and/or clothing, and which has increased flexibility and permeation resistance compared to conventional barrier materials for protective clothing. In this manner, a flexibility and wearability of protective clothing may be improved, thus enhancing wearer comfort and dexterity compared with conventional protective clothing. The laminate material of the invention may also be used in other types of protective equipment, such as respirators, where enhanced flexibility and permeation resistance may be desirable.

According to a first aspect of the invention, there is provided a laminate material comprising: a first layer formed of a rubber material; and a second layer formed of an activated carbon cloth; wherein the first layer and the second layer are joined together.

The first layer of the laminate material may act as an outer barrier layer which is arranged to block permeation of substances (e.g. liquid and/or gas substances). The second layer may act as an inner barrier which acts as a sponge that captures any substances which have managed to permeate through the first layer. In particular, as the second layer is made of activated carbon cloth (ACC) it has a very high capacity for adsorption, such that it can contain substances which have permeated through the first layer for extended periods of time. Thus, the combination of the first layer and the second layer may provide a laminate material which is highly effective at blocking permeation of dangerous substances, and which can withstand permeation for extended periods of time.

For a given thickness, the laminate material of the invention may have a greater flexibility compared to a conventional barrier material (e.g. rubber) of the same thickness. This is because part of the thickness of the laminate material is made of ACC, which has a much higher flexibility compared with rubber. Furthermore, a given thickness of the laminate material of the invention may have a greater permeability resistance compared with a conventional barrier material (e.g. rubber) of the same thickness. This is due to the second layer made of ACC which, as noted above, can adsorb substances which have permeated through the first layer for extended periods of time, thus leading to a higher overall permeability resistance of the laminate material. As a result, a given level of permeability resistance can be achieved using a smaller thickness of the laminate material of the invention compared with a conventional barrier material. In this manner, the laminate material of the invention can be used to make lighter and more flexible protection clothing or equipment, without compromising on wearer safety. Moreover, due to its lighter and more flexible nature, the laminate material of the invention may enable greater levels of wearer dexterity compared to conventional barrier materials.

The first layer is formed of a rubber material. Any suitable type of rubber material may be used. Examples of rubber materials include, but are not limited to, natural rubber, polyisoprene rubber, butyl rubber, halo-butyl rubber, polychloroprene rubber, ethylene propylene diene monomer (EPDM) rubber, nitrile rubber, polyurethane rubber and silicone rubber.

The rubber material of the first layer may be cured, or vulcanised, in order to enhance its permeation resistance.

The second layer is formed of ACC. ACC, which may also be referred to as activated carbon fabric (ACF), includes materials comprising a cloth substrate which contains activated carbon. The cloth substrate may be in the form of a woven cloth, a nonwoven cloth, a knitted cloth, felt, or other cloth-like material. The activated carbon may be incorporated into the cloth or be part of the cloth itself, and can be provided in various forms including activated carbon particles, activated carbon powder, activated carbon fibres, as well as combinations of these. The carbon may be activated during manufacture to increase its surface area available for adsorption, as known in the art. Herein, the term cloth is intended to cover any type of cloth, fabric or textile.

Advantageously, in the laminate material of the invention, the cloth component of the ACC may act to wick any substances that have permeated through the first layer, thus causing the substances to be distributed within the second layer. This may avoid high concentrations of dangerous substances arising in localised areas, as well as avoid saturation of the activated carbon in areas where permeation has occurred. Due to these effects of the ACC, a permeation resistance of the of laminate material may be greatly enhanced compared with a conventional barrier material such as a single layer of rubber.

Relative thicknesses of the first and second layers, as well as a total thickness of the laminate material may be selected based on an intended use of the material, in order to provide desired flexibility and permeation resistance characteristics. As an example, in some cases the second layer may have a greater thickness than the first layer. This may increase an ability of the laminate material to absorb substances which have permeated through the first layer, as well as enhance a flexibility of the laminate material.

The first layer and the second layer are joined together. In other words, the first layer and the second layer are secured (e.g. bonded) together. In this manner, the laminate material may act as a single piece of material, thus facilitating manipulation and use of the laminate material. This may also ensure that the second layer is appropriately positioned to absorb any substances that have permeated through the first layer. The first layer and the second layer may be joined together using any suitable techniques, several of which are discussed below. Joining between the first layer and the second layer may refer to a mechanical bond, a chemical bond, an adhesive bond, and/or any other suitable type of bond between the two layers for joining them together. The first and second layer may be directly or indirectly joined together, i.e. they may be in direct contact with one another or there may be an intermediate layer between the first and second layers which acts to bond them together.

In some embodiments, the first layer and the second layer may be directly joined (e.g. bonded) together. In other words, there may be an interface between the first layer and the second layer, where the first layer and the second layer are in direct contact. Joining between the first layer and the second layer may occur at the interface. The joining between first layer and second layer may include chemical and/or mechanical bonding. For example, some of the rubber of the first layer may penetrate into the second layer, such that there is a mechanical bonding (e.g. interlocking) between the rubber and fibres of the ACC. This may be achieved by heating the rubber and compressing it onto the ACC, such that the rubber at the interface melts or softens to form a bond with the ACC. Additionally or alternatively, there may be some chemical interaction at the interface between materials in the first layer and the second layer which results in chemical bonding between the first and second layers.

A benefit of directly joining the first layer to the second layer is that a total thickness of the laminate material may be reduced, as this avoids any intermediate material between the first and second layers. As a result, a flexibility of the laminate material may be improved, which in turn enables more flexible and lightweight protective clothing to be produced. Additionally, this may simplify manufacture of the laminate material, as the number of materials and processes involved in the manufacturing process may be reduced.

Where the first layer and the second layer are directly joined together, the rubber material of the first layer may not penetrate all the way through the second layer. In other words, although the rubber material may in some cases partially penetrate into the second layer, it does not penetrate all the way through the second layer. This may ensure that the rubber material of the first layer does not provide a permeation path through the entire thickness of the laminate material. In this manner, when the laminate material is used in protective clothing, any substance which has permeated through the first layer must also pass through the second layer before reaching a wearer's skin.

In other embodiments, the first layer and the second layer may be joined together via an adhesive. For example, the laminate material may comprise an adhesive layer located between the first layer and the second layer. This may provide a simple and reliable mechanism for joining (i.e. bonding) the first and second layers together. This may also avoid any penetration of the rubber material from the first layer into the second layer, which may maximise an effectiveness of the second layer. Any suitable type of adhesive may be used for joining the layers together. As an example, the adhesive may be a rubber-based adhesive.

An outer surface of the first layer may be textured. This may serve to improve a grip of the outer surface of the first layer. Thus, for example, where the laminate material is used to make a glove, the textured outer surface of the first layer may facilitate gripping objects. Any suitable type of texturing on the outer surface of the first layer may be used. For example, the texturing may include one or more of dimples, bumps, grooves, ridges, corrugations, etc. The texturing of the outer surface of the first layer may be provided using any suitable technique. In some cases, the outer surface of the first layer may be textured during fabrication of the first layer, e.g. where the first layer is formed by moulding the rubber material. Alternatively, the outer surface may be textured during manufacture of the laminate material, e.g. by compressing the first layer onto the second layer with a textured plate or calender roll.

The laminate material of the invention is not limited to the first and second layers recited above, and may include further layers to further improve performance of the laminate material. For example, the laminate material may include an inner layer, wherein the second layer is located between the first layer and the inner layer. The inner layer may act as a protective layer, e.g. to prevent direct contact between a wearer's skin and the second layer. In some cases, the inner layer may be a fabric layer (e.g. formed of a lightweight fabric), which may serve as a lining to enhance comfort for the wearer. The inner layer may be joined to the second layer using any suitable technique, e.g. such as with an adhesive.

In some embodiments, the laminate material may further include an additional protective material, wherein the protective material is an adsorbent material, and wherein the protective material is disposed in the second layer and/or in a third layer joined to the second layer. The additional protective material may serve to enhance the protective properties of the laminate material, as the protective material may act to capture substances which have permeated through the first layer. Thus, the ACC and the additional protective material may cooperate to block permeation of substances through the laminate material. The protective material may include any suitable material having absorbent and/or adsorbent properties. An example of such a protective material is metal-organic frameworks (MOFs). MOFs are compounds formed of metal ions or clusters which are coordinated to organic molecules. MOFs have a porous structure, enabling them to absorb various substances. Accordingly, inclusion of MOFs in the laminate material may improve its ability to resist permeation of substances through the material.

The protective material (e.g. MOFs) may be included in the second layer, e.g. the protective material may be loaded into the ACC. Additionally or alternatively the protective material may be provided in a third layer, i.e. on a separate substrate. The third layer may be joined to the second layer on an opposite side of the second layer compared to the first layer. The third layer may be joined to the second layer using any suitable technique, e.g. such as with an adhesive. As an example, the third layer may comprise a cloth (or fabric) in which the protective material is loaded. In some cases, the third layer may thus form the inner layer mentioned above. Otherwise, the inner layer may be separate from the third layer, such that the third layer is disposed between the second layer and the inner layer.

The MOFs may be included in the second layer, e.g. they may be loaded into the ACC. Alternatively, the MOFs may be provided on a separate substrate. The separate substrate may form an inner layer, which is joined to the second layer.

The laminate material of the invention may be compatible with touchscreens, including capacitive touchscreens. In particular, the inventors have found that the activated carbon included in the second layer may provide sufficient levels of conductivity within the material to enable interaction with a capacitive touchscreen. Accordingly, where the laminate material of the invention is used for forming a glove, a wearer will be able to interact with a capacitive touchscreen. The rubber material of the first layer may contain carbon black, which enhance compatibility of the laminate material with capacitive touchscreens.

Additionally, the enhanced flexibility of the laminate material compared with conventional barrier materials may improve a wearer's ability to interact with other types of touchscreens, such as resistive touchscreens.

The laminate material of the invention may be in the form of a planar sheet. For example, the laminate material may be formed by joining together substantially planar sheets of rubber material and ACC.

Alternatively, the laminate material of the invention may conform to a three-dimensional (3D) shape. For example, the laminate material may be shaped to form all or part of a wearable, such as a glove. This may be achieved using a variety of manufacturing techniques. For example, the rubber material of the first layer may be formed by moulding it into a desired 3D shape. The second layer may be formed into a corresponding 3D shape, e.g. moulding the ACC material into the desired 3D shape or by assembling multiple pieces of the ACC material to form the desired 3D shape. The first and second layers can then be joined together, to form a laminate material conforming to the desired 3D shape.

The laminate material of the invention may be used in a wearable item, e.g. in protective clothing. Thus, according to a second aspect of the invention, there is provided a wearable item comprising a laminate material according to the first aspect of the invention. Any features discussed above in relation to the first aspect of the invention may be shared with the second aspect of the invention.

As discussed above, using the laminate material of the invention in a wearable item may make the wearable item more lightweight and provide it with enhanced flexibility and permeability resistance compared with a corresponding wearable item made from conventional barrier materials. Thus, the wearable item of the second aspect of the invention may be more comfortable and facilitate a greater range of movement of the wearer. In this manner, a safety of the wearer may be improved, whilst enabling the wearer to wear the wearable item for longer periods of time and to complete a wide range of tasks in a hazardous environment.

The first layer may be arranged such that it is closer to an outside of the wearable item, whilst the second layer may be arranged such that it is closer to an inside of the wearable item. In this manner, the first layer may act as an outer barrier layer which blocks permeation of substances from the environment into the wearable item. If a substance from the environment manages to permeate through the first layer, it will then reach the second layer where it can be adsorbed. For example, the first layer may be exposed on an outer surface of the wearable item, e.g. an outer surface of the first layer may form an outer surface of the wearable item. The second layer may be arranged such that it forms an inner surface of the wearable item, e.g. the second layer may be arranged to contact the wearer's skin.

The wearable item may be an item of protective clothing, e.g. CBRN protective clothing. The wearable item may also be a piece of protective equipment, such as a respirator of face mask.

The wearable item may be a glove. For example, the wearable item may be a CBRN protective glove. The enhanced flexibility of the laminate material of the invention may improve a dexterity of the user when wearing the glove, compared to when wearing conventional CBRN rubber gloves. In particular, as the thickness of the laminate material may be reduced compared with conventional barrier materials whilst still retaining suitable permeation resistance, a level of wearer dexterity may be greatly improved. This may enable the wearer to perform a variety of complex tasks in a hazardous environment requiring high levels of dexterity, which would have previously been very difficult with conventional thick rubber gloves.

According to a third aspect of the invention, there is provided a method of manufacturing a laminate material, the method comprising: providing a first layer formed of a rubber material, and a second layer formed of an activated carbon cloth; arranging the first layer and the second layer in a stack; and joining the first layer and the second layer together. The method of the third aspect of the invention may be used to produce the laminate material of the first aspect of the invention. Therefore, any features discussed above in relation to the first aspect of the invention may be shared with the third aspect of the invention. The method of the third aspect of the invention may also form part of a process for manufacturing a wearable item according to the second aspect of the invention.

In some embodiments, joining the first layer and the second layer together may comprise applying heat and pressure to the stack to bond the first layer and the second layer together.

Arranging the first layer and the second layer in a stack, and applying heat and pressure to the stack enables the first layer and the second layer to be directly joined (e.g. bonded) together. Thus, in line with the discussion above, an interface between the first layer and the second layer may be formed, at which bonding between the first layer and the second layer occurs. In particular, the inventors have found that the combination of applied heat and pressure to the stack results in effective bonding between the two layers. The applied heat may promote bonding (e.g. mechanical and/or chemical bonding) between the first and second layer, whilst the applied pressure may serve to promote effective and uniform bonding across the interface. For example, in some cases, the applied heat may act to soften or partially melt the rubber material of the first layer. Then, due to the application of pressure, some of the softened or partially melted rubber material may penetrate into the second layer, such that the first layer and the second layer become mechanically interlocked. The applied heat and pressure may also promote chemical bonding at the interface between the first layer and the second layer, depending on the materials used in the two layers.

The heat and pressure may be applied to the stack using various techniques, as discussed below. The temperature and pressure used for joining the layers may be selected based on the specific materials used in the first and second layers and the thicknesses of the layers, to provide adequate bonding between the two layers.

The first layer formed of rubber material may be produced using any suitable manufacturing technique. The first layer may, for example, be provided in the form of a sheet or swatch of rubber material.

In some cases, the first layer may be produced by moulding the rubber material, e.g. to produce a first layer having a desired shape, including a three-dimensional (3D) shape. This may, for example, facilitate providing a surface texture on an outer surface of the first layer, and/or forming the laminate material into wearable item having a complex shape.

The second layer formed of ACC may be produced using any suitable manufacturing technique for making ACC. The second layer may be provided in various forms, such as a sheet or swatch of ACC. In some cases, the second layer may be pre-formed into a desired shape, e.g. into a 3D shape. This may be achieved, for example, through a moulding process and/or by joining multiple section of ACC together to form a desired shape.

Herein, arranging the first layer and the second layer in a stack may mean that the first layer is placed on the second layer (or vice versa). The first layer and the second layer may be arranged in a stack such that the first layer and the second layer are in direct contact with one another.

In some cases, the application of heat to the stack may cure the rubber material in the first layer. In this manner, the process of applying heat and pressure to the stack may serve to both cure (or ‘vulcanise’) the rubber material and bond the two layers together. The rubber material which is provided for the first layer may therefore be uncured prior to the step of applying heat and pressure to the stack. Advantageously, this enables the rubber material to be cured whilst it is in contact with the second layer, thus promoting effective bonding between the first and second layers. The temperature and duration of heat application to the stack may be selected based on the rubber material used in the first layer, to ensure that the rubber material is completely cured by the end of the process.

Applying heat and pressure to the stack may comprise compressing the stack with a heated plate. This provides a simple and efficient technique for bonding the layers together, and enables the production of a sheet or swatch of the laminate material. The plate used for compressing the stack may have a heating element, such that the plate is directly heated by the heating element. Alternatively, the process may be performed in a heated chamber (e.g. in an oven), with the plate being located in the heated chamber, such that the plate and stack are heated together.

The heated plate may be a flat plate, or it may be shaped, e.g. to conform with the shape of an item to be produced with the laminate material.

The heated plate may be applied to the first layer, such that the rubber material is simultaneously heated and compressed into the second layer. This may promote efficient bonding between the first and second layers, as well as curing of the rubber material. The heated plate may be textured, such that a texture is applied to the first layer when the heated plate is pressed onto the first layer.

Alternatively, applying heat and pressure to the stack may comprise passing the first layer and the second layer through heated calender rolls. This may facilitate large volume manufacture of the laminate material, as a continuous sheet of laminate material may be produced by feeding sheets corresponding to the first and second layers through the calender rolls. Thus, the first layer may be provided in the form of a sheet of rubber material, whilst the second layer may be provided in the form of a sheet of ACC. The two sheets may then be fed through the heated calender rolls, one or top of the other, such that the heated calender rolls bond the two sheets together. The calender rolls may be arranged to apply a pressure to the sheets as they pass through the calender rolls, to compress the rubber material onto the ACC. The calender rolls may be heated to a temperature suitable for promoting bonding between the two layers, and for curing the rubber material if the rubber material is uncured.

One of the heated calendar rolls (e.g. the one which contacts the first layer) may have a textured surface, such that a texture is applied to the surface of the first layer.

In some embodiments, joining the first layer and the second layer together may comprise applying an adhesive between the first layer and the second layer to bond the first layer and the second layer together. Thus, as discussed above in relation to the first aspect of the invention, the first and second layers can be bonded together without application of pressure and heat, by simply using an adhesive.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a schematic diagram showing a cross-sectional view of a laminate material according to an embodiment of the invention;

FIG. 2 is a photograph showing a cross-section of a laminate material according to an embodiment of the invention;

FIG. 3 is a schematic diagram showing a cross-sectional view of a press that can be used in a method of manufacturing a laminate material according to the invention;

FIG. 4 is a schematic diagram showing a cross-sectional view of a calendering system that can be used in a method of manufacturing a laminate material according to the invention; and

FIG. 5 is a schematic diagram showing a cross-sectional view of a laminate material according to an embodiment of the invention.

### DETAILED DESCRIPTION OF THE INVENTION

Aspects and embodiments of the present invention will now be discussed with reference to the accompanying figures. Further aspects and embodiments will be apparent to those skilled in the art.

FIG. 1 is a schematic diagram showing a cross-sectional view of a laminate material 100 according to an embodiment of the invention. The laminate 100 includes a first layer 102 which is formed of a cured rubber material, and a second layer 104 which is formed of an activated carbon cloth (ACC). The first layer 102 and the second layer 104 are joined together, such that the laminate material 100 behaves as a single piece of material. In particular, the first layer 102 and the second layer 104 are directly joined together, i.e. they are bonded at an interface between the two layers where the two layers contact one another. The bonding between the two layers may be mechanical and/or chemical, depending on the specific materials used in the layers and the manufacturing process. The rubber material of the first layer 102 may include various types of rubber materials, such as natural rubber, polyisoprene rubber, butyl rubber, halo-butyl rubber, polychloroprene rubber, ethylene propylene diene monomer (EPDM) rubber, nitrile rubber, polyurethane rubber and silicone rubber. The ACC material of the second layer may comprise a cloth or fabric which carries activated carbon, e.g. in the form of activated carbon particles, activated carbon powder and/or activated carbon fibres.

The laminate material 100 may be used in protective clothing and/or equipment, e.g. to prevent dangerous substances in the environment from reaching a user's skin. The first layer 102 acts as an outer barrier which blocks or impedes permeation of substances. The second layer 104 acts as an inner adsorbing layer, which can capture and retain any substances which have managed to permeate through the first layer 102. In this manner, the laminate material 100 may form an effective barrier against substance permeation. In some cases, an outer surface 106 of the first layer 102 (i.e. a surface of the first layer 102 that faces away from the second layer 104) may be textured. For example, the outer surface 106 may have bumps, dimples, corrugation or some other form of surface texturing provided thereon. This may serve to enhance a grip of the outer surface 106, e.g. which may be beneficial where the laminate is used in a glove.

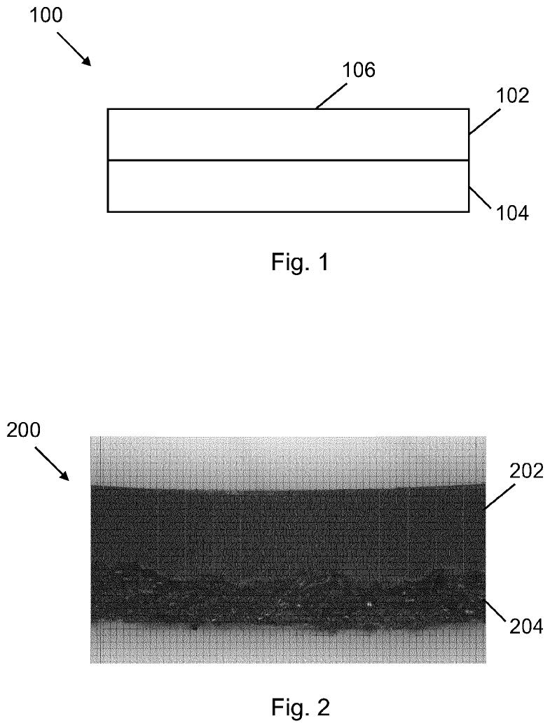

FIG. 2 is a photograph of a cross-section of a laminate material 200, which has a same structure as the laminate material 100 described above. In particular, the laminate material 200 includes a first layer 202 made of chlorobutyl rubber which is directly joined to a second layer 204 made of a nonwoven cloth that is impregnated with activated carbon. As can be seen, the interface between the first layer 202 and the second layer 204 is textured (i.e. it is not completely flat), which promotes adhesion between the two layers. Additionally, parts of the rubber material of the first layer 202 penetrate into the second layer 204, thus forming a strong mechanical bond between the two layers. However, as can be seen, penetration of the first layer 202 into the second layer is limited to a small region around the interface between the two layers. In other words, the rubber material of the first layer 202 does not penetrate all the way through the second layer 204. This ensures that the rubber material does not provide a permeation path all the way through the thickness of the laminate material 200. In the example shown, the first layer 202 has a thickness of about 0.6 mm, and the second layer 204 has a thickness of about 0.3 mm.

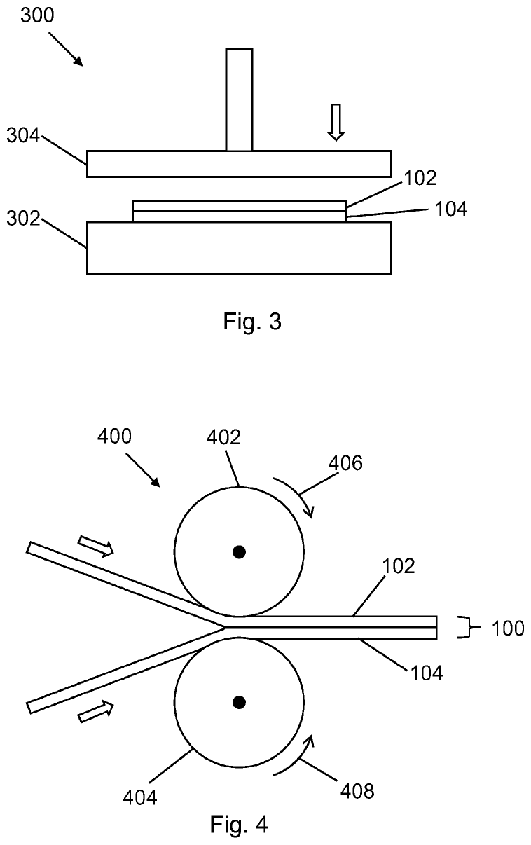

FIG. 3 is a schematic diagram illustrating a process that can be used for manufacturing the laminate material 100 discussed above. FIG. 3 shows a cross-sectional view of a press 300 which is used for forming the laminate material. In a first step, a sheet of rubber material forming the first layer 102 and a sheet of ACC forming the second layer 104 are stacked on top of a base plate 302 of the press 300. For example, as shown in FIG. 3, the first layer 102 may be placed on top of the second layer 104 to form a stack on the base plate 302. At this stage, the rubber material of the first layer 102 is uncured. The first layer 102 may be pre-fabricated using any suitable manufacturing technique. For example, the first layer 102 may be formed by moulding the rubber material to produce a layer having a desired shape and thickness. If the outer surface 106 of the first layer 102 includes surface texturing, this may be provided as part of the moulding process. The second layer 104 may be pre-fabricated using any suitable technique for making ACC. The second layer 104 may be cut into a swatch of a desired shape and size, e.g. so that it matches a shape of the first layer 102.

After placing the first and second layers 102, 104 on the base plate 302 as shown in FIG. 3, a top plate 304 of the press 300 is pressed towards the base plate 302 to compress the stack of layers between the top plate 304 and the base plate 302. Heat is simultaneously applied to the stack whilst it is compressed between the top plate 304 and the base plate 302. This may be achieved, for example, by heating the top plate 304, e.g. via a heating element located in the top plate 304. Alternatively, this may be achieved by locating the press 300 in an oven, and heating the press 300 and stack in the oven. The combination of pressure and heat applied to the stack acts to bond the first layer 102 and the second layer 104 together, as well as to cure the rubber material of the first layer 102. The pressure and temperature applied to the stack, as well as the duration for which pressure and heat are applied to the stack, may be adapted to the specific materials used in the first and second layers 102, 104, to ensure effective bonding between the layers and that the rubber material is fully cured.

As an example, the laminate material 200 shown in FIG. 2 was formed using the process illustrated in FIG. 3. The first layer 202 was pre-fabricated by moulding, and was placed on the second layer 204 in the press 300. The first layer 202 and the second layer 204 were then compressed together between the top plate 304 and the base plate 302 with a pressure in a range between 1 N/mm² and 10 N/mm² and at a temperature in a range between 100° C. and 200° C. The high temperature was applied by heating the top plate 304.

In the example of FIG. 3, the press 300 is configured to produce a laminate material which has a substantially planar shape. However, in some cases it may be desirable to produce the laminate material such that it conforms to a particular 3D shape, e.g. to facilitate incorporating it into a wearable item of piece of protective equipment. In such a case, the first layer 102 and the second layer 104 may be pre-formed so as to conform to the desired 3D shape, e.g. via moulding or other suitable manufacturing techniques. Then, the shapes of the top plate 304 and the base plate 302 may be adapted to the 3D shape, to enable formation of the laminate material in accordance with the desired 3D shape.

FIG. 4 is a schematic diagram illustrating another process that can be used to manufacture the laminate material 100. FIG. 4 shows a side cross-sectional view of a calendering system 400 which is used for forming the laminate material. The calendering system 400 includes a pair of heated calender rolls 402, 404, through which two sheets of material can be fed to become bonded together. In particular, as shown, a first sheet of rubber material for forming the first layer 102, and a second sheet of ACC for forming the second layer 104 are fed through the heated calender rolls 402, 404. The heated calender rolls 402, 404 rotate as shown by arrows 406, 408 to draw the sheets for the first and second layers through a gap between the heated calender rolls 402, 404. The heated calender rolls 402, 404 are arranged such that the first and second layers 102, 104 are compressed together in the gap between the heated calender rolls 402, 404. In particular, the gap between the heated calender rolls 402, 404 may be made smaller than the sum of the thicknesses of the two sheets. The heated calender rolls 402, 404 are heated, such that they apply heat to the first and second layers 102, 104 as they pass through the gap between the heated calender rolls 402, 404. Accordingly, the first and second layers 102, 104 are compressed together and heated as they pass through the gap between the heated calender rolls 402, 404, causing the first and second layers 102, 104 to become bonder together, and the rubber material of the first layer 102 to become cured. The temperature of the heated calender rolls 402, 404 and their speed of rotation may be adjusted, in order to ensure effective bonding the first and second layers 102, 104 and that the rubber material is completely cured. Thus, the system 400 may enable production of long continuous sheets of the laminate material 100, which may facilitate large scale production of the laminate material 100.

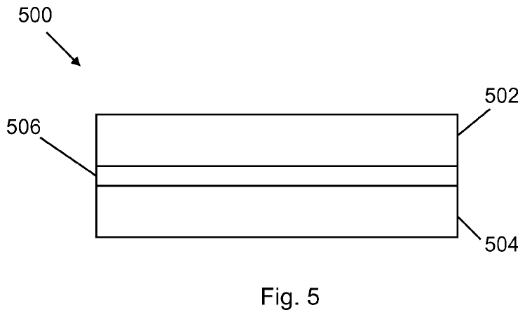

FIG. 5 is a schematic diagram showing a cross-sectional view of a laminate material 500 according to another embodiment of the invention. The laminate 500 includes a first layer 502 which is formed of a cured rubber material, and a second layer 504 which is formed of an activated carbon cloth (ACC). The first layer 502 and the second layer 504 may be made of the same materials and fulfil the same functions as the first and second layers 102, 104 of the laminate material 100 discussed above. A third layer 506 formed of an adhesive material is located between the first layer 502 and the second layer 504, and acts to bond the first and second layers 502, 504 together. Using the third layer 506 made of adhesive for bonding the first and second layers 502, 504 may provide a simple and effective technique for bonding the two layers together, without having to perform the compression and heating processes discussed above (although the rubber material of the first layer 502 may still need to be cured). However, including the third layer 506 in the laminate material 500 increases a thickness of the laminate material 500 compared to the laminate material 100 discussed above.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

1. A laminate material comprising:
a first layer formed of a rubber material; and
a second layer formed of an activated carbon cloth;
wherein the first layer and the second layer are joined together.

2. A laminate material according to claim 1, wherein the first layer and the second layer are directly joined together.

3. A laminate material according to claim 2, wherein the rubber material of the first layer does not penetrate all the way through the second layer.

4. A laminate material according to claim 1, wherein the first layer and the second layer are joined together via an adhesive.

5. A laminate material according to claim 1, wherein an outer surface of the first layer is textured.

6. A laminate material according to claim 1, further comprising an inner layer, wherein the second layer is located between the inner layer and the first layer.

7. A laminate material according to claim 1, further comprising an additional protective material, wherein the protective material is an adsorbent material, and wherein the protective material is disposed in the second layer and/or in a third layer joined to the second layer.

8. A laminate material according to claim 1, wherein the laminate material forms a planar sheet.

9. A laminate material according to claim 1, wherein the laminate material conforms to a three-dimensional shape.

10. A wearable item comprising a laminate material according to claim 1.

11. A wearable item according to claim 9, wherein the wearable item is a glove.

12. A method of manufacturing a laminate material, the method comprising:
providing a first layer formed of a rubber material, and a second layer formed of an activated carbon cloth;
arranging the first layer and the second layer in a stack; and
joining the first layer and the second layer together.

13. A method according to claim 12, wherein the first layer is provided by moulding the rubber material.

14. A method according to claim 12, wherein joining the first layer and the second layer together comprises applying heat and pressure to the stack to bond the first layer and the second layer together.

15. A method according to claim 14, where the application of heat to the stack cures the rubber material in the first layer.

16. A method according to claim 14, wherein applying heat and pressure to the stack comprises compressing the stack with a heated plate.

17. A method according to claim 14, wherein applying heat and pressure to the stack comprises passing the first layer and the second layer through heated calendar rolls.

18. A method according to claim 12, wherein joining the first layer and the second layer together comprises applying an adhesive between the first layer and the second layer to bond the first layer and the second layer together.
